(19) United States
(12) Patent Application Publication
(10) Pub. No.: US 2026/0050949 A1
(43) Pub. Date: Feb. 19, 2026

(54) CURATION ENGINE FOR PROGRAMMATIC ADVERTISING

(71) Applicant: SWYM Enterprises, Inc., Mount Sinai, NY (US)

(72) Inventors: Ravi Patel, Mount Sinai, NY (US); Andrew Scott Altersohn, Westfield, NJ (US); Kenneth Scott Rona, Atlanta, GA (US); Kevin Nelson Marshall, Gillette, NJ (US)

(21) Appl. No.: 19/299,631

(22) Filed: Aug. 14, 2025

Related U.S. Application Data
(60) Provisional application No. 63/684,112, filed on Aug. 16, 2024.

(51) Int. Cl. G06Q 30/0273; G06Q 30/0241; G06Q 30/0272

(52) U.S. Cl. CPC G06Q 30/0275; G06Q 30/0272; G06Q 30/0277

(57) ABSTRACT

A curation engine monitors the performance of demand side bidding activity, relative to advertiser objectives, and provides responsive inventory selection criteria for use in generating more relevant supply side offerings to an ad exchange.

### CROSS-REFERENCE TO RELATED APPLICATIONS

This application claims priority to U.S. Provisional Patent Application No. 63/684,112 filed on Aug. 16, 2024, where the foregoing application is hereby incorporated by reference in their entirety.

### TECHNICAL FIELD

This disclosure relates to techniques for intelligently curating offers for advertising space in a programmatic advertising environment.

### BACKGROUND

Programmatic advertising systems regularly fail to deliver optimal results. On one hand, the inventory of available advertising space on the supply side is opaque to advertisers because the very high volume and dynamic nature of available advertising space requires supply side entities to throttle offers of inventory to the market. On the other hand, the interest in available inventory is opaque to content publishers (who have the available space to sell) because interest is only communicated to the market via specific price/parameter bids from demand side entities. This double-blind market prevents price signals from mediating supply and demand in programmatic online advertising.

There remains a need for a programmatic advertising platform that supports improved communication between supply side inventory and demand side interest, and more specifically a platform that enhances market signaling beyond the bid/ask auction-type transactions that occur on a conventional advertising exchange.

### SUMMARY

A curation engine monitors the performance of demand side bidding activity, relative to advertiser objectives, and provides responsive inventory selection criteria for use in generating more relevant supply side offerings to an ad exchange.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 shows a networked environment for programmatic advertising.

FIG. 2 is a diagram of a computing device for use in the methods and systems described herein.

FIG. 3 shows a programmatic advertising environment.

FIG. 4 illustrates a curation engine in a programmatic advertising process.

FIG. 5 shows a method for curating advertisements in a programmatic advertising process.

FIG. 6 illustrates a curation engine.

FIG. 7 illustrates improved signaling between the demand side platform and the supply side platform resulting from the use of a curation engine.

### DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better describe the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

To provide an overall understanding of the disclosure, certain illustrative implementations will now be described, including systems, methods, and devices for curating advertising space inventory in a programmatic advertising environment. However, it will be understood by one of ordinary skill in the art that the systems and methods described herein may be adapted and modified as is appropriate and that the systems and methods described herein may be employed in other suitable applications, and that such other additions and modifications will not depart from the scope thereof. Generally, the computerized systems described herein may comprise one or more engines, platforms, modules, compute instances, or the like, which may include a processing device or devices, such as a computer, microprocessor, logic device, or other device or processor that is configured with hardware, firmware, and/or software to carry out one or more of the computerized methods described herein.

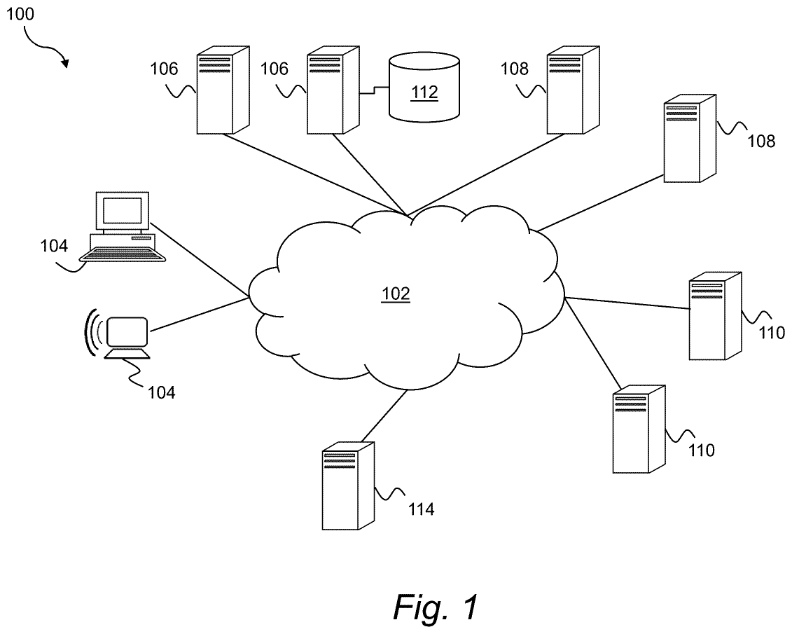

FIG. 1 shows a networked environment for programmatic online advertising. In general, the environment 100 may include a data network 102 interconnecting a plurality of participating devices in a communicating relationship. The participating devices may, for example, include any number of client devices 104, servers 106, content sources 108, and other resources 110, e.g., to perform the various functions and services described herein.

The data network 102 may be any network(s) or internetwork(s) suitable for communicating data and information among participants in the environment 100. This may include public networks such as the Internet, private networks, telecommunications networks such as the Public Switched Telephone Network or cellular networks using third generation (e.g., 3G or IMT-2000), fourth generation (e.g., LTE (E-UTRA) or WiMax-Advanced (IEEE 802.16m)) and/or other technologies, as well as any of a variety of corporate area or local area networks and other switches, routers, hubs, gateways, and the like that might be used to carry data among participants in the environment 100.

Each of the participants of the data network 102 may include a suitable network interface comprising, e.g., a network interface card, which term is used broadly herein to include any hardware (along with software, firmware, or the like to control operation of same) suitable for establishing and maintaining wired and/or wireless communications. The network interface card may include without limitation a wired Ethernet network interface card (“NIC”), a wireless 802.11 networking card, a wireless 802.11 USB device, or other hardware for wired or wireless local area networking. The network interface may also or instead include cellular network hardware, wide area wireless network hardware or any other hardware for centralized, ad hoc, peer-to-peer, or other radio communications that might be used to connect to a network and carry data. In another aspect, the network interface may include a serial or USB port to directly connect to a local computing device such as a desktop computer that, in turn, provides more general network connectivity to the data network 102.

The client devices 104 may include any devices within the environment 100 operated by users for programmatic advertising as described herein. Specifically, the client devices 104 may include any device for presenting web content to users, configuring ad space offerings or bids, administering demand side or supply side infrastructure, operating an advertising exchange, and so forth, as well as managing, monitoring, or otherwise interacting with tools, platforms, and devices included in the systems and methods contemplated herein. By way of example, the client devices 104 may include one or more desktop computers, laptop computers, network computers, tablets, mobile devices, portable digital assistants, messaging devices, cellular phones, smart phones, portable media or entertainment devices, or any other computing devices that can participate in the environment 100 as contemplated herein, and be used to configure demand side or supply side programmatic buying activity and so forth. As discussed above, the client devices 104 may include any form of mobile device, such as any wireless, battery-powered device, that might be used to interact with the networked environment 100. It will also be appreciated that one of the client devices 104 may coordinate related functions (e.g., searching, storing an entity profile, etc.) as they are performed by another entity such as one of the servers 106, content sources 108 or other resources 110.

Each client device 104 may generally provide a user interface, such as any of the user interfaces described herein. The user interface may be maintained by a locally executing application on one of the client devices 104 that receives data from, e.g., the servers 106 and content sources 108 concerning an entity. In other embodiments, the user interface may be remotely served and presented on one of the client devices 104, such as where a server 106 or one of the other resources 110 includes a web server that provides information through one or more web pages or the like that can be displayed within a web browser or similar client executing on one of the client devices 104. The user interface may in general create a suitable visual presentation for user interaction on a display device of one of the client devices 104, and provide for receiving any suitable form of user input including, e.g., input from a keyboard, mouse, touchpad, touch screen, hand gesture, or other use input device(s).

The servers 106 may include data storage, a network interface, and a processor and/or other processing circuitry. In the following description, where the functions or configuration of a server 106 are described, this is intended to include corresponding functions or configuration (e.g., by programming) of a processor of the server 106. In general, the servers 106 (or processors thereof) may perform a variety of processing tasks related to programmatic online advertising including managing supply side content, demand side parameters, bidding on an advertising exchange, hosting the advertising exchange, monitoring advertisement placement and performance, hosting a curation engine, and so forth. The servers 106 may also or instead include backend algorithms that react to actions performed by a user at one or more of the client devices 104, including underlying financial transactions, advertisement delivery and monitoring, and so forth. The backend algorithms may also or instead be located elsewhere in the environment 100.

The servers 106 may also include a web server or similar front end that facilitates web-based access by the client devices 104 to the capabilities of the server 106. A server 106 may also or instead communicate with the content sources 108 and other resources 110 in order to obtain information for providing to a user through a user interface on the client device 104.

A server 106 may also maintain a database 112 of content, along with an interface for users at the client devices 104 to perform searches and retrieval of database content using any of the techniques provided herein (e.g., automatically through an action performed on an entity profile). Thus, in one aspect, a server 106 (or any system including the server 106) may include a database 112 of information such as transaction history, available inventory, advertising content, and so forth. In the current context, the content sources 108 may, for example, include content publishers that provide online content and, when the online content is delivered to a user device 104, includes space for advertising that can be offered to advertisers as the content is rendered for an end user.

The content sources 108 may include any sources of hosted content. For example, the content sources 108 may include without limitation Web pages (e.g., public or private pages), search engines or search services, interfaces to various search services, application program interfaces (APIs) to remote sources of data, local or remote databases (e.g., private databases, corporate databases, government databases, institutional databases, educational databases, and so forth), libraries, other online resources, social networks, computer programs and applications, other entity profiles, and so forth. The content sources 108 may include various types of information and data including without limitation textual information (e.g., published or unpublished information such as books, journals, periodicals, magazines, newspapers, treatises, reports, legal documents, reporters, dictionaries, encyclopedias, blogs, wikis, and so forth), graphical information (e.g., charts, graphs, tables, and so forth), images or other visual data (e.g., photographs, drawings, paintings, plans, renderings, models, sketches, diagrams, computer-aided designs, and so forth), audio data, numerical data, geographic data, scientific data (e.g., chemical composition, scientific formulas, and so forth), mathematical data, and so forth.

The other resources 110 may include any resources that may be usefully employed in the devices, systems, and methods as described herein. For example, the other resources 110 may include without limitation other data networks, human actors (e.g., programmers, researchers, annotators, editors, and so forth), sensors (e.g., audio or visual sensors), text mining tools, web crawlers, knowledge base acceleration (KBA) tools or other content monitoring tools, and so forth. The other resources 110 may also or instead include any other software or hardware resources that may be usefully employed in the networked applications as contemplated herein. For example, the other resources 110 may include payment processing servers or platforms used to authorize payment for content subscriptions, content purchases, or otherwise. As another example, the other resources 110 may include social networking platforms that may be used, e.g., to share an entity profile or other research conducted by a user, or as additional sources of entity information. In another aspect, the other resources 110 may include certificate servers or other security resources for third party verification of identity, encryption or decryption of content, and so forth. In another aspect, the other resources 110 may include a desktop computer or the like co-located (e.g., on the same local area network with, or directly coupled to through a serial or USB cable) with one of the client devices 104. In this case, the other resource 110 may provide supplemental functions for the client device 104. Other resources 110 also include supplemental resources such as scanners, cameras, printers, and so forth.

The environment 100 may include one or more web servers 114 that provide web-based access to and from any of the other participants in the environment 100. While depicted as a separate network entity, it will be readily appreciated that a web server 114 may be logically or physically associated with one of the other devices described herein, and may, for example, include or provide a user interface for web access to one of the servers 106 (or databases 112 coupled thereto), one of the content sources 108, or any of the other resources 110 in a manner that permits user interaction through the data network 102, e.g., from a client device 104.

It will be understood that the participants in the environment 100 may include any hardware or software to perform various functions as described herein. For example, one or more of the client device 104 and the server 106 may include a memory and a processor.

The various components of the networked environment 100 described above may be arranged and configured to support the techniques described herein in a variety of ways.

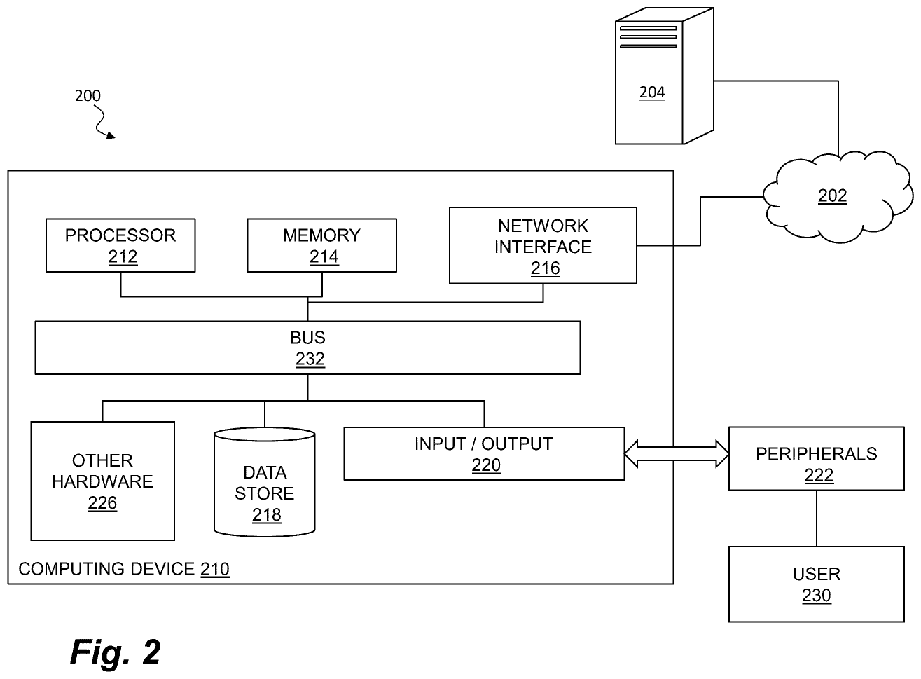

FIG. 2 is a diagram of a computer system 200 for use in the methods and systems described herein. In general, the computer system 200 of FIG. 2 may be used to implement any of the programmatic advertising market functions or related functions or services described herein.

The computer system 200 may include a computing device 210 connected to a network 202, e.g., through an external device 204. The computing device 210 may be or include any type of network endpoint or endpoints as described herein. For example, the computing device 210 may include a desktop computer workstation. The computing device 210 may also or instead be any other device that has a processor and communicates over a network 202, including without limitation a laptop computer, a desktop computer, a personal digital assistant, a tablet, a mobile phone, a television, a set top box, a wearable computer, and so forth. The computing device 210 may also or instead include a server, or it may be disposed on a server or within a virtual or physical server farm. In certain aspects, the computing device 210 may be implemented using hardware (e.g., in a desktop computer), software (e.g., in a virtual machine or the like), or a combination of software and hardware (e.g., with programs executing on the desktop computer), and the computing device 210 may be a standalone device, a device integrated into another entity or device, a platform distributed across multiple entities, or a virtualized device executing in a virtualization environment.

The network 202 may include any network or combination of networks, such as one or more data networks or internetworks suitable for communicating data and control information among participants in the computer system 200. The network 202 may include public networks such as the Internet, private networks, and telecommunications networks such as the Public Switched Telephone Network or cellular networks using third generation cellular technology (e.g., 3G or IMT-2000), fourth/fifth generation cellular technology (e.g., 4G, LTE, MT-Advanced, E-UTRA, 5G, etc.) or WiMAX-Advanced (IEEE 802.16m)) and/or other technologies, as well as any of a variety of corporate area, metropolitan area, campus, or other local area networks or enterprise networks, along with any switches, routers, hubs, gateways, and the like that might be used to carry data among participants in the computer system 200. The network 202 may also include a combination of data networks, and need not be limited to a strictly public or private network.

The external device 204 may be any computer or other remote resource that connects to the computing device 210 through the network 202. This may include threat management resources such as any of those contemplated above, gateways or other network devices, remote servers or the like containing content requested by the computing device 210, a network storage device or resource, a device hosting content, or any other resource or device that might connect to the computing device 210 through the network 202.

The computing device 210 may include a processor 212, a memory 214, a network interface 216, a data store 218, and one or more input/output interfaces 220. The computing device 210 may further include or be in communication with one or more peripherals 222 and other external input/output devices connected to an input/output interface 220.

The processor 212 may be any as described herein, and in general may be capable of processing instructions for execution within the computing device 210 or computer system 200. In one aspect, the processor 212 may be capable of processing instructions stored in the memory 214 or on the data store 218.

The memory 214 may store information within the computing device 210 or computer system 200. The memory 214 may include any volatile or non-volatile memory or other computer-readable medium, including without limitation a Random-Access Memory (RAM), a flash memory, a Read Only Memory (ROM), a Programmable Read-only Memory (PROM), an Erasable PROM (EPROM), registers, and so forth. The memory 214 may store program instructions, program data, executables, and other software and data useful for controlling operation of the computing device 210 and configuring the computing device 210 to perform functions for a user. While a single memory 214 is depicted, it will be understood that any number of memories may be usefully incorporated into the computing device 210. For example, a first memory may provide non-volatile storage such as a disk drive for permanent or long-term storage of files and code even when the computing device 210 is powered down, and a second memory such as a random-access memory may provide volatile (but higher speed) memory for storing instructions and data for executing processes.

The network interface 216 may include any hardware and/or software for connecting the computing device 210 in a communicating relationship with other resources through the network 202. This may include connections to resources such as remote resources accessible through the Internet, as well as local resources available using short range communications protocols using, e.g., physical connections (e.g., Ethernet), radio frequency communications (e.g., WiFi or Bluetooth), optical communications, (e.g., fiber optics, infrared, or the like), ultrasonic communications, or any combination of these or other media that might be used to carry data between the computing device 210 and other devices. The network interface 216 may, for example, include a router, a modem, a network card, an infrared transceiver, a radio frequency (RF) transceiver, a near field communications interface, a radio-frequency identification (RFID) tag reader, or any other data reading or writing resource or the like. More generally, the network interface 216 may include any combination of hardware and software suitable for coupling the components of the computing device 210 to other platforms, computing or communications resources, and so forth.

The data store 218 may be any internal memory store providing a computer-readable medium such as a disk drive, an optical drive, a magnetic drive, a flash drive, memory card, or other device capable of providing mass storage for the computing device 210. The data store 218 may store computer readable instructions, data structures, program modules, and other data for the computing device 210 or computer system 200 in a non-volatile form for subsequent retrieval and use. The data store 218 may store computer executable code for an operating system, application programs, and other program modules, software objects, libraries, executables, and the like. The data store 218 may also store program data, databases, files, media, and so forth.

The input/output interface 220 may support input from and output to other devices that might couple to the computing device 210. This may, for example, include serial ports (e.g., RS-232 ports), universal serial bus (USB) ports, optical ports, Ethernet ports, telephone ports, audio jacks, component audio/video inputs, HDMI ports, and so forth, any of which might be used to form wired connections to other local devices. This may also or instead include an infrared interface, RF interface, magnetic card reader, or other input/output system for coupling in a communicating relationship with other local devices.

The peripherals 222 may include any device or combination of devices used to provide information to or receive information from the computing device 210. This may include human input/output (I/O) devices such as a keyboard, a mouse, a mouse pad, a track ball, a joystick, a microphone, a foot pedal, a camera, a touch screen, a scanner, or other device that might be employed by the user 230 to provide input to the computing device 210. This may also or instead include a display, a speaker, a printer, a projector, a headset, or any other audiovisual device for presenting information to a user or otherwise providing machine-usable or human-usable output from the computing device 210. The peripheral 222 may also or instead include a digital signal processing device, an actuator, or other device to support control of or communication with other devices or components.

Other hardware 226 may be incorporated into the computing device 210 such as a co-processor, a digital signal processing system, a math co-processor, a graphics engine, a video driver, and so forth. The other hardware 226 may also or instead include expanded input/output ports, extra memory, additional drives (e.g., a DVD drive or other accessory), and so forth.

A bus 232 or combination of buses may serve as an electromechanical platform for interconnecting components of the computing device 210 such as the processor 212, memory 214, network interface 216, other hardware 226, data store 218, and input/output interface 220. As shown in the figure, each of the components of the computing device 210 may be interconnected using a system bus 232 or other communication mechanism for communicating information.

Methods and systems described herein can be realized using the processor 212 of the computer system 200 to execute one or more sequences of instructions contained in the memory 214 to perform predetermined tasks. In embodiments, the computing device 210 may be deployed as a number of parallel processors synchronized to execute code together for improved performance, or the computing device 210 may be realized in a virtualized environment where software on a hypervisor or other virtualization management facility emulates components of the computing device 210 as appropriate to reproduce some or all of the functions of a hardware instantiation of the computing device 210.

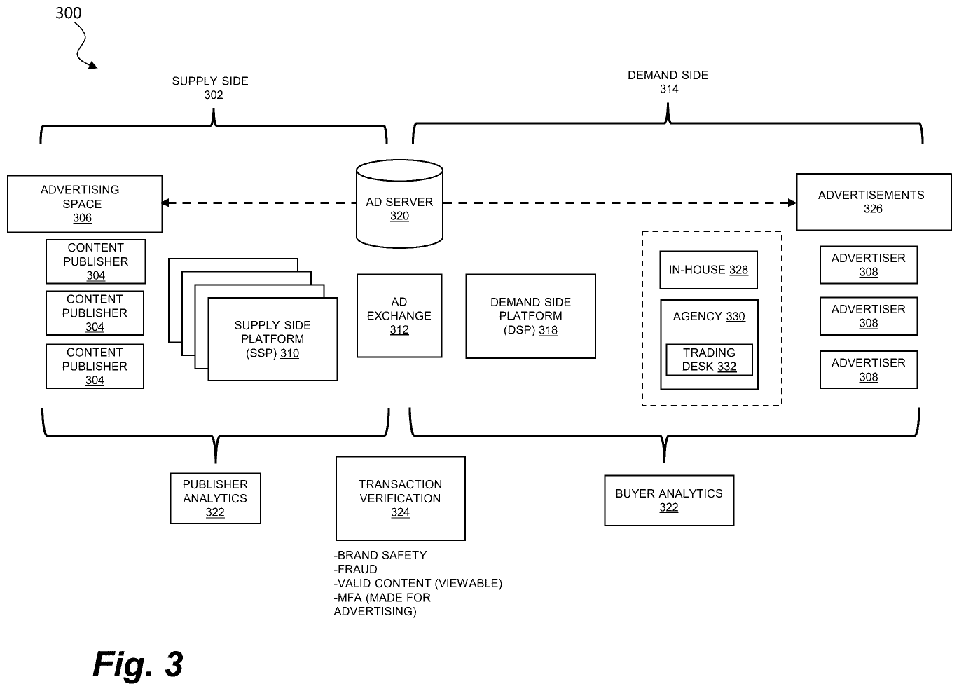

FIG. 3 shows a programmatic advertising environment 300. In general, a supply side 302 includes a plurality of content publishers 304 who publish online content with associated advertising space 306 that is available for purchase by third parties. The supply side 302 couples the content publishers 304 to advertisers 308 via a supply side platform 310 and/or advertising exchange 312. The supply side 302 may also provide publisher analytics 322 that can be tracked by content publishers 304 or third parties, and shared within the programmatic advertising environment to support, e.g., improved placement of advertisements.

The demand side 314 may include a plurality of advertisers 308 who have advertisements 326 that they would like to present to users online. The advertisers 308 may be any providers of corresponding content, such as an in house 328 advertising group or department for an advertiser, an agency 330 that provides advertising for third parties, or a trading desk 332 that provides advertisement placement services, or any combination of these. The demand side 314 couples these advertisers 308 to the advertising exchange 312 through a demand side platform 318. In general, the advertising exchange 312, which may be integrated into the supply side platform 310 and/or demand side 314, connects advertisers 308 to advertising space 306 through an auction-style bidding process in which advertisers 308 programmatically bid on available space that is offered by content publishers 304. The advertisement exchange 312 resolves offers and bids to select a particular bid from a particular demand side platform 318 for placement of advertisements 326 into a particular, offered advertising space 306. After a purchase is completed, the advertisement server 320, which may be integrated into or separate from the advertisement exchange 312, can deliver advertisements 326 to users who are viewing the content from the content publisher 304. Thus, in one aspect, the advertisement server 320 may be configured to present an advertisement from an advertiser in web content from one of the publishers in response to completing a sale on the exchange.

A variety of analytics 322 may be gathered, e.g., from content publishers 304, from the supply side platform 310, from the demand side platform 318, from the advertisement exchange 312, and/or from independent transaction verification resources 324.

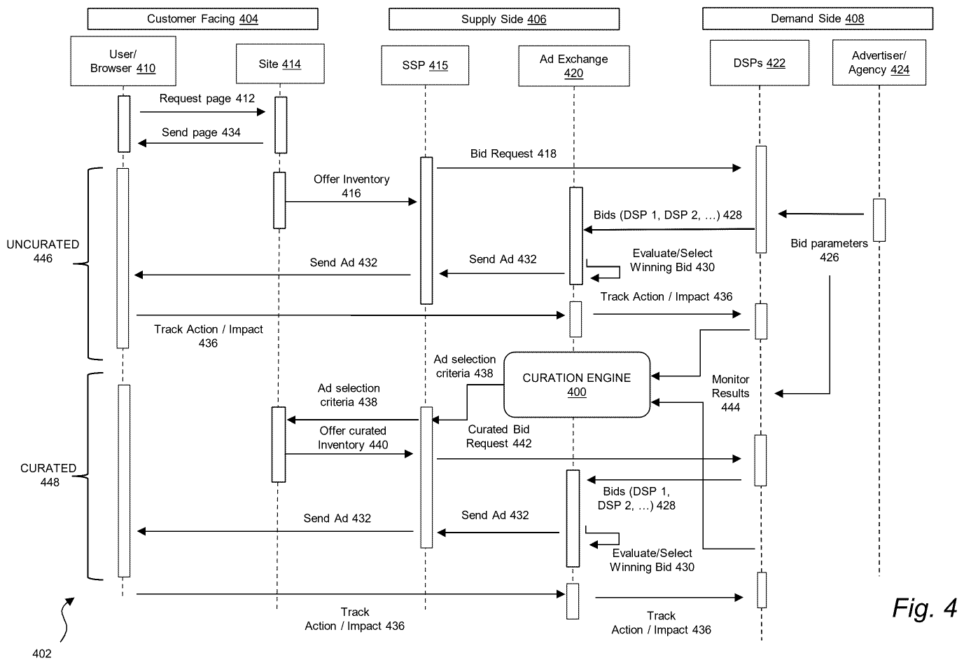

FIG. 4 illustrates a curation engine 400 in a programmatic advertising environment 402. An uncurated programmatic advertising process 446 (without the curation engine 400) and a curated programmatic advertising process 448 (using the curation engine 400) are shown.

In general, the programmatic advertising environment 402 may include a customer facing side 404, a supply side 406, and a demand side 408. The customer facing side 404 may include a user/browser 410 that requests a webpage 412. Once the user/browser 410 requests a webpage 412, the receiving site 414 may responsively send the requested webpage 412 to the user/browser, and include the advertising space in the page in an offer of inventory 416 communicated to the supply side 406 where a supply side platform 415 may bundle the offered inventory with other inventory as appropriate, and communicate a resulting bid request 418 to one or more demand side platforms 422 of the demand side 408. The demand side platform(s) 422 may send corresponding bids to the advertising exchange 420 where an auction 430 or similar process is used to evaluate the bids and select a winning bid for ad placement. In response to the winning bid, the advertising exchange 420 may transmit corresponding instructions to the advertisement server (described above) so that the corresponding advertisements can be delivered 432 to the supply side platform 422 and the user/browser 410 for rendering in the page along with the content from the site 414.

In general, a bid request 418 may include information about the user/browser 410 including the user, the device, the advertisement inventory, the environment, and any auction constraints or preferences. More specifically, the bid request 418 may include information about the user, device, and browser details for the user/browser 410, advertisement inventory details, application or website information, auction parameters, regulatory and privacy signals, video specific fields, and so forth. The information about the user (of the user/browser 410) may include one or more of a user identification, demographics, behavioral segments, and a geographic location. The device and browser details may include one or more of the device type, the operating system and version, the browser, the screen size, the IP address, and description of the user/browser 410 environment. The inventory details may include one or more of the advertisement slot size, the placement of the advertisement, the position of advertisement on the webpage, and contextual data such as but not limited to a page content category, keywords, and a URL/domain. The application or website information may include one or more of an application identification or website URL which may be used to identify a publisher's property, a bundle identification for mobile applications which may be used to identify a specific application, a publisher identification for targeting or excluding the publisher, and a content rating. The auction parameters may include one or more of an auction type, a floor price, an identification for the auction deal, and a type of currency. The regulatory and privacy signals may include one or more of General Data Protection Regulation flags, California Consumer Privacy Act flags, Children's Online Privacy Protection Act flags, and Children's Online Privacy Protection Act flags. The video-specific fields may include one or more of the maximum and minimum video length allowed, whether a video can be skipped, the playback method, and Video Ad Serving Template tag requirements. More generally, any conventional, propriety, standardized, or other information useful for parameterizing a bid may be included in a bid request as contemplated herein.

In general, a bid request 418 may be sent to an advertisement exchange 420 or directly to demand side platforms 422. Once demand side platforms 422 receive a bid request 418, the demand side platforms may 422 may filter the bid requests based on one or more parameters 426 defined by the advertisers 424 such as performance metrics, target audience, budget constraints, advertisement campaign goals, and creative eligibility (e.g., format compatibility). Filtering based on creative eligibility ensures that only advertisement creatives (the actual advertisement assets) that are technically and contextually compatible with the publisher's inventory (i.e., the advertisement slot) are considered for bidding. Creative eligibility factors may include but are not limited to advertisement media format, advertisement size, device/operating system compatibility, Video Ad Serving Template, Video Player-Ad Interface Definition, regulatory filters, media types, and category or brand exclusions. In real time, the demand side platforms 422 may use machine learning models, user behavior predictions, and conversion probability estimations to decide whether to bid, how much to bid, and which advertisement asset(s) to use. In general, if a bid request 418 from the supply side 406 matches the criteria for an advertising campaign, the demand side platform 422 generates a bid 428.

The advertisement exchange 420 may receive the bids 428 from the demand side platforms 422 and select a winning bid 430. The advertisement associated with the winning bid may be sent 432 through the supply side platform 415 and displayed to the user/browser 410 when the page from the site 414 is rendered at the user/browser 410. Advertisement performance data such as but not limited to impressions, clicks, conversions, and so forth, may be tracked 436 and sent to the supply side platforms 415 and demand side platforms 422 for logging and analysis.

The supply side platforms 415 typically have a large inventory and may only offer a portion of the inventory when offering inventory 416 to the demand supply platforms 422. The portion of the inventory is may be arbitrarily separated and bundled when offered 416 to the supply side platforms 415, e.g., according to purely internal metrics or constraints of the inventory owner, thereby resulting in an offer of inventory that is uncorrelated to performance metrics for advertisers 424, and/or the omission of inventory that may be of high interest to advertisers 424 based on advertiser objectives. This inefficiency results in offers of low-interest inventory, and corresponding failures to offer high-interest inventory. At the same time, typical market mechanisms for aligning buyer and seller interests—such as price and quantity—cannot properly function to resolve this inventory mismatch due to the opacity of inventory held by sites 414. This results in lower bids received by the supply side platforms 415, wasted time and resources by the demand side platforms 422 when evaluating inventory that is not of interest, and a reduced return on advertisement spend by the demand side platforms when relevant inventory is arbitrarily not shown. Therefore, there remains a need for improved techniques when offering advertisement inventory that permit signaling of demand side purchasing metrics in the absence of transparent inventory pricing.

In general, the curation engine 400 may receive bid parameters 426 from advertisers 424 about, e.g., performance metrics, key performance indicators, objectives, budgets, and so forth, for an advertising campaign. The curation engine 400 may also receive tracking data, e.g., from the demand side platform 422 or supply side platform 415, after individual advertisements are sent 432. The curation engine 400 may evaluate the performance of the bids 428 from a demand side platform 422 relative to the objectives 426 of an advertiser 424 in order to determine how an advertising campaign is performing relative to its objectives 426. This can be used to generate responsive advertisement selection criteria 438 that can be presented to the supply side platform 415 to improve supply side processing of offer inventory and create improved bid requests 418. In particular, the supply side platform 415 can use the selection criteria 438 from the curation engine 400 to filter incoming inventory and identify curated inventory 440 that is more likely to be responsive to user interest, as expressed by the advertiser(s) 424 to the curation engine 400. The resulting bid request (the “Curated Bid Request” 442 in FIG. 4) should provide greater value to advertisers 424 and fetch an improved or more accurate price on the advertisement exchange 420. It will be understood that in this context, the term “filter” includes filtering in the conventional sense, e.g., selecting a subset of inventory presented by sites 414, as well as shaping the bid request stream proactively by requesting specific types of inventory from inventory owners.

This approach has numerous advantages. By permitting advertisers 424 to specify performance metrics, the curation engine 400 can objectively monitor performance 444 of resulting advertisements. This further permits the curation engine 400 to specify inventory of interest, using the parameters available to supply side 406 and demand side 408 entities so that the supply side platform 415 can focus a bid request on inventory that is more likely to be of interest to the advertisers 424.

According to the foregoing, in one aspect a system disclosed herein includes: an exchange hosting a bidstream for transacting in online programmatic advertisements; a supply side platform for programmatic access to the exchange by publishers seeking to sell advertising space in a computer network; a demand side platform for programmatic access to the exchange by an advertiser seeking to place advertisements on the advertising space in the computer network; and a curation engine. The curation engine may generally be configured to monitor one or more characteristics for advertisements placed by the advertiser with the publishers through the exchange, predict one or more supply side parameters that will improve positive advertisement impressions for the advertiser based on the one or more characteristics, and request that the supply side platform provide additional advertising space from the publishers to the bidstream meeting the one or more supply side parameters, or more generally, to support bidstream curation as described herein. The curation engine may also or instead support demand side enhancements. For example, the curation engine may include a bidding engine configured to assess inventory in the bidstream and adjust bidding by the advertiser based on whether the inventory meets a performance metric.

In one aspect, the curation engine may include a machine learning model trained to predict the one or more supply parameters that will improve positive advertisement impressions for the advertiser based on the one or more characteristics. The curation engine may also or instead include a rules engine to predict the one or more supply parameters that will improve positive advertisement impressions for the advertiser based on the one or more characteristics. The one or more supply parameters may include one or more of geography, audience, publisher, site, domain, advertisement format, device type, media type, floor price, viewability, contextual data, 3^{rd} party data, and publisher category. The one or more characteristics for advertisements may include one or more of site, domain, advertisement format, media type, exchange, auction type, DealID, time, viewability, brand safety, fraud, geography, cost, clicks, conversions, and bid price. The bidding engine may adjust the bidding based on at least one price parameter. In one aspect, the publishers may provide web content, or any other content accessible through a data network such as the Internet. The advertising space may include advertising space presented to user computers in web browsers while displaying the web content. The system may also include an advertisement server configured to present an advertisement from an advertiser in web content from one of the publishers in response to completing a sale on the exchange.

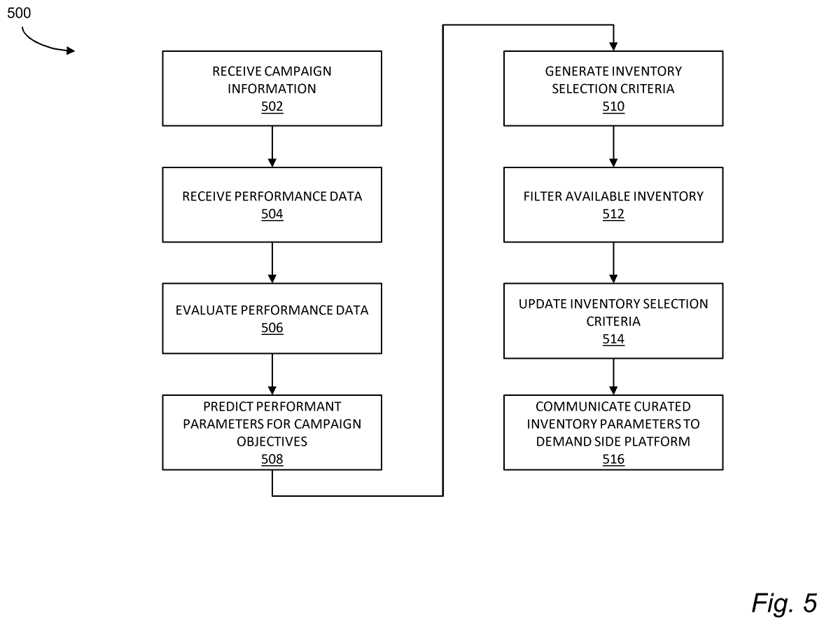

FIG. 5 shows a method for curating advertisements in a programmatic advertising environment, such as any of the programmatic advertising environments described above. In general, the method 500 may include steps performed aby a curation engine or similarly configured entity executing on one or more computing devices, and may also or instead interact with other entities in the environment as more generally described herein.

As shown in step 502, the method may include receiving campaign information. In some embodiments, the curation engine receives campaign information from an advertiser through an application programming interface (API) or other programmatic interface. The campaign information can include at least one performance objective defined by the advertiser, such as a target click-through rate (CTR), conversion rate, cost per acquisition (CPA), or viewability threshold. This information may also include budget constraints, brand safety requirements, creative format restrictions, target audience segments, and regulatory compliance signals. By capturing this data in a structured format, the curation engine is able to align its subsequent inventory curation operations with the advertiser's specific goals.

As shown in step 504, the method 500 may include receiving performance data. The curation engine may receive performance data for advertisements that were previously placed in advertising inventory offered through a supply side platform (SUPPLY SIDE PLATFORM). Such performance data may be collected from ad servers, SUPPLY SIDE PLATFORM logs, demand side platform (DSP) reports, and third-party verification services. Example metrics can include impressions served, clicks recorded, conversions achieved, viewability scores, fraud detection results, and cost data. This historical and in-market performance data may be stored in a local or cloud-based database accessible by the curation engine for real-time and batch processing.

As shown in step 506, the method 500 may include evaluating performance data. In general, once the performance data is received, the curation engine may evaluate the data relative to the at least one performance objective defined in the campaign information. This evaluation may include calculating aggregated metrics, determining whether performance thresholds were met, and identifying trends in the effectiveness of different inventory types. For example, the evaluation may reveal that a certain publisher domain, ad format, or geographic region consistently produces above-average conversions for the campaign. The evaluation process may use statistical analysis, heuristic scoring, or machine learning models to generate a set of performance characteristics that describe the conditions under which the campaign objectives are most likely to be met. More generally, this may include an evaluation using any of the machine learning techniques described herein, or any other algorithms, rule-based techniques, heuristics, or machine learning techniques, as well as combinations of the foregoing, suitable for aligning site inventory with advertiser demand.

As shown in step 508, the method 500 may include, e.g., based on the determined performance characteristics, predicting one or more supply side parameters for inventory that is more likely to achieve the at least one performance objective. These parameters can include, for example, publisher identifiers, site domains, content categories, floor prices, geographic targeting constraints, device types, media formats, and audience segments. In some implementations, the prediction is performed by a trained machine learning model that uses both historical and real-time campaign data to identify correlations between inventory attributes and high-performing ad placements.

As shown in step 510, the method 500 may include generating inventory selection criteria. From the predicted supply side parameters, the curation engine may generate inventory selection criteria that can be applied to filter available inventory on the SUPPLY SIDE PLATFORM. The selection criteria may take the form of structured rules, parameter ranges, or weighted scoring functions that define the subset of inventory deemed most relevant to the advertiser's campaign objectives. These criteria can be formatted for compatibility with SUPPLY SIDE PLATFORM APIs so that they can be programmatically applied to the incoming bidstream.

As shown in step 512, the method 500 may include filtering available inventory. In one aspect, this may include generating inventory selection criteria. From the predicted supply side parameters, the curation engine may generate inventory selection criteria that can be applied to filter available inventory on the SUPPLY SIDE PLATFORM. The selection criteria may take the form of structured rules, parameter ranges, or weighted scoring functions that define the subset of inventory deemed most relevant to the advertiser's campaign objectives. These criteria can be formatted for compatibility with SUPPLY SIDE PLATFORM APIs so that they can be programmatically applied to the incoming bidstream. Using the generated inventory selection criteria, the curation engine may filter available inventory from the SUPPLY SIDE PLATFORM to identify curated inventory that matches the advertiser's campaign requirements. This filtering process may be performed in real time or near real time, ensuring that only the inventory most likely to achieve the desired performance outcomes is passed into the bidstream for consideration by the advertiser's DSP. By filtering out irrelevant or low-performing inventory, the curation engine reduces processing overhead and improves the efficiency of bidding operations.

As noted herein, filtering in this context may include selecting a subset of available inventory identified to the curation engine as described above, and/or filtering may include communicating inventory of interest to the supply side, and/or directly to the source(s) of supply side inventory for supply side curation or otherwise shaping the bidstream so that more demand-relevant inventory can be surfaced for bidding. Thus, in one aspect, filtering may include transmitting a curated inventory request of ad selection criteria to the supply side. In general, the curation engine may transmit a request for the SUPPLY SIDE PLATFORM to offer curated inventory into the bidstream. This request may be sent as a curated bid request containing the inventory selection criteria, DealID references, or other identifiers that enable the SUPPLY SIDE PLATFORM to assemble the specified subset of inventory for auction. By transmitting curated requests, the curation engine ensures that the bidstream contains inventory aligned with the advertiser's objectives, improving bid relevance and overall campaign performance.

In another aspect, filtering may include modeling or otherwise aggregating information about available inventory at the curation engine. With this information, the curation engine can proactively request inventory that is known to exist and to be responsive to advertiser demand, but that is not in the current bidstream, or that is not presented in the bidstream in a manner responsive to advertiser performance parameters.

As shown in step 514, the method 500 may include updating the inventory selection criteria over time. For example, inventory selection criteria may be based on subsequent performance data for advertisements placed using the curated inventory. After the curated inventory has been offered into the bidstream and advertisements have been placed, the curation engine may collect new performance data from multiple sources, such as SUPPLY SIDE PLATFORM logs, DSP reports, ad server analytics, and third-party verification services. This subsequent performance data may include metrics such as impressions served, click-through rates, conversion counts, viewability percentages, fraud detection outcomes, and cost-per-result values, each of which is associated with the specific inventory parameters that were applied during curation.

This information may be used in turn to update performance data against the advertiser's defined performance objectives to detect changes in inventory effectiveness over time. In some implementations, this is performed using machine learning models or statistical optimization routines that recalculate the relative importance of individual supply side parameters, such as publisher domains, audience segments, advertisement formats, or geographic regions. The resulting analysis may produce revised inventory selection criteria that reflect the most recent performance trends and market conditions. By continuously refining the selection criteria based on live campaign outcomes, the curation engine can advantageously adapt to dynamic inventory availability and shifting audience behaviors, thereby improving bid relevance, reducing wasted impressions, and increasing the probability of achieving the advertiser's performance objectives in future auctions.

As shown in step 516, the method 500 may include transmitting curated inventory parameters to the demand side platform. In some embodiments, the curation engine may be configured to transmit curated inventory parameters to a demand side platform (DSP) to inform bid pricing and pacing adjustments for an active advertising campaign. Curated parameters derived from the curation engine's analysis-such as prioritized publisher domains, audience segment identifiers, geographic targeting constraints, advertisement format preferences, and floor price recommendations—can be delivered downstream to the DSP as part of an intelligent decisioning process. This transmission can occur through a programmatic interface, such as an API or direct bidstream injection, enabling the DSP to incorporate the curated parameters into its real-time bidding logic.

The DSP may use the curated parameters to dynamically adjust bid prices for impressions that match the curated inventory profile, thereby allocating higher bids to high-value opportunities and reducing spend on lower-probability conversions. In addition, pacing algorithms within the DSP can be modified in response to the curated parameters, for example, to accelerate spending on inventory predicted to exceed key performance indicators or to conserve budget when high-value inventory availability is limited. By integrating curated inventory data directly into the DSP's bid and pacing engines, the system can advantageously support closed-loop optimization between the supply curation process and demand-side decision-making, reducing bid inefficiency and improving overall campaign return on ad spend.

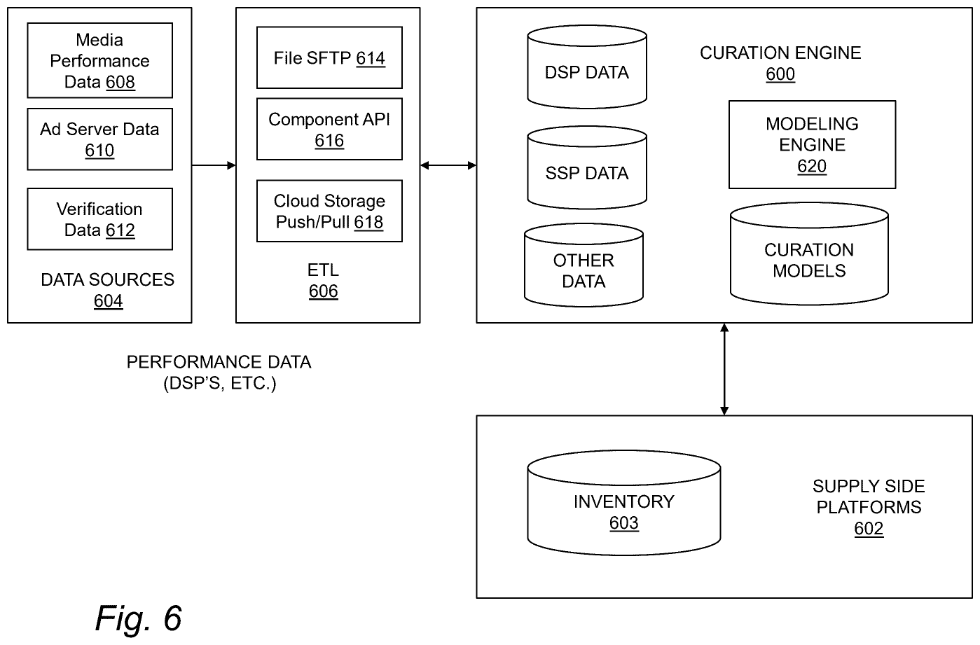

FIG. 6 illustrates a curation engine 600. In general, the curation engine 600 may be integrated into both the demand (DSP) & supply (SUPPLY SIDE PLATFORM) technology stacks, which enables a bi-directional signaling between market participants by learning and adjusting to signals from both sides. In one aspect, the curation engine 600 may learn characteristics of performing inventory and automatically create curation information for transmittal to the supply side via API integrations with Supply side platforms 602 (“SUPPLY SIDE PLATFORMs 602”). At the same time, the curation engine may integrate sell-side data and insights into demand decisioning to modify/adjust bid prices and bid pacing on behalf of buyers to help buyers pay appropriate prices for each curated impression.

In general, only a subset of the total available supply (<50%) of inventory 603 is available on advertisement exchanges due to the very large volume of inventory, and the subset is generally selected by SUPPLY SIDE PLATFORMs 602 based on aggregate, non-specific signals. As a result, each buyer only has the opportunity to bid on the subset of supply of inventory 603 selected for them, which may or may not be appropriate or optimal for each specific campaign. As a significant advantage, the curation engine 600 improves the relevance of available supply by providing explicit instructions to the SUPPLY SIDE PLATFORMs 602 on what inventory 603 to offer. These instructions may be provided in the form of rules, parameters, and the like, for the supply side to deliver specific types of inventory for purchase by advertisers. The curation engine 600 can deploy intelligent, dynamic (e.g., daily) curation of media to improve the probability of successful ad impressions as measured by Key Performance Indicators for advertisers. More specifically, buyers get increased access to the inventory supply through curation that is intermediated by the curation engine 600, resulting in a curated supply that is selected and fed into the bidstream based on signals and in-market behavior that is modeled and analyzed by the curation engine 600.

The curation engine 600 may use a variety of techniques to identify patterns and relationships between the parameters of campaigns and the observed results in order to perform bid request curation and shaping in near-real time. For example, the curation engine can model historical and in-market buy-side performance and attribution signals to discern patterns and relationships between various elements of each campaign to learn the characteristics of top performing inventory based on each campaign's key performance indicators. Data sources 604 may be extracted, transformed, and loaded into the curation engine model(s). The data sources 604 may be extracted, transformed, and loaded 606, for example, by file SFTP 614, component API 616, and/or cloud storage push/pull 618, depending on the structure, format, and interfaces of the underlying data sources 604. The data sources 604 may include, e.g., DSP (Demand Side Platform) daily reporting information, media performance data 608, ad server data 610, and verification data 612. Optionally, additional sources can be added to deepen the richness of the signals, which can include DSP log data, Attribution data, Mixed Media Model data or other bespoke performance signals. On one hand, this may include interpreting demand side parameters such as site/domain, advertisement format, device type, media type, advertising environment, exchange, auction type, deal ID, time, viability, brand safety, fraud, geography, cost, clicks, conversions, bid price, and so forth. On the other hand, this may include providing curation instructions based on supply side parameters such as geography, audience, publisher, site/domain, advertisement format, device type, media type, floor price, viability, contextual data, 3^{rd} party data, win rate, bid availability, publisher category, and so forth. It will be noted that not all of these parameters or signals will be used in all cases. But it should be noted that the supply side platform data context will frequently be different than the demand side platform context. Thus, in one aspect, the curation engine 600 advantageously provides a resource for converting explicit advertiser objectives or parameters into specific, curated requests for inventory from the content publishers.

The curation engine 600 may read and process the loaded data. In one aspect, the curation engine 600 may process the data using a modeling engine 620 to create and store, e.g., machine learning models and the like for use in curation of inventory 603 hosted by the supply side platforms 602. A variety of techniques may be used by the curation engine 600 to determine which inventory parameters yield the highest performing inventory. For example, this may include machine learning models trained to predict inventory parameters for curation that are most important for achieving demand side performance indicators.

In some embodiments, the machine learning model is specifically trained to improve the operation of the curation engine within the programmatic advertising environment by enabling more efficient and accurate selection of advertising inventory from throttled supply sources. The training process may include ingesting large-scale historical performance datasets from both supply side platforms and demand side platforms, such datasets including impression-level attributes (e.g., device type, media format, placement coordinates, page context metadata, auction type, and bid floor) and corresponding outcome metrics (e.g., click-through rates, conversion rates, viewability scores). In addition, the model may be incrementally updated with in-market performance data streamed in near real time, allowing the curation engine to adapt to changing user behaviors, publisher inventory conditions, and advertiser objectives. The training may be performed using supervised learning in which labeled outcomes are derived from observed campaign performance, and the feature space is engineered to represent bidstream inventory attributes in a normalized, machine-readable format optimized for rapid scoring in live auctions. This specialized training may advantageously improve the functioning of the overall system by reducing bidstream latency, increasing the precision of curated inventory selection, and dynamically aligning supply-side offerings with advertiser-defined performance objectives-results that cannot be achieved through conventional, non-curated auction processing or through conventional price signaling to align supply and demand.

In one aspect, this may include scoring each combination of inventory dimensions to calculate a predicted KPI. Once a predicted KPI has been determined, performant inventory can be identified, based on the needs of each specific client. After a KPI has been modeled in this manner, the client budget can be examined to identify performant inventory that corresponds to a budget allocation. The curation engine 600 can then create a curated list of the best performing inventory according to the identified, prioritized dimensions, and through API access, the curation engine 600 can send a curated list of inventory to supply side platforms 602 for use in shaping the bidstream. A DealID or other mechanism may then be used to monitor campaign performance. The curated inventory can be updated, e.g., every week, or at any other suitable interval based on client reporting requirements and so forth.

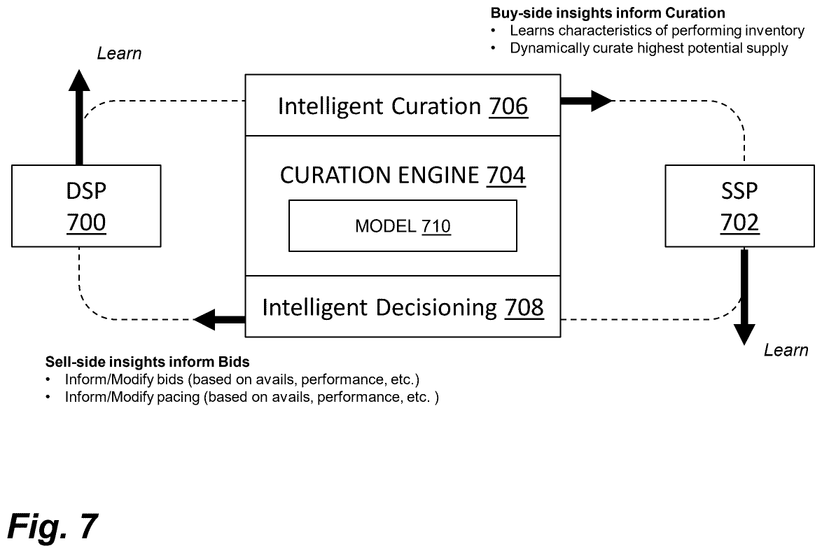

FIG. 7 illustrates improved signaling between the demand side platform 700 and the supply side platform 702 resulting from the use of a curation engine 704. In general, the curation engine 704 permits demand side buying interest to be expressed in terms of performance metrics, rather than simply price. At the same time, the curation engine 704 permits signaling to the supply side platform 702 that permits selection of relevant inventory from a throttled supply source, so that arbitrary throttling limits do not prevent exposure of inventory that is of interest to buyers. This results in intelligent curation 706 that may dynamically curate the highest potential supply based on characteristics of performing inventory, and in intelligent decisioning 708 that may inform or modify bids and the pacing of the bids.

In certain embodiments, the training of a machine learning model 710 for the curation engine 704 is tightly integrated with the bi-directional signaling framework between supply side platforms 702 and demand side platforms 700 as illustrated, e.g., in FIG. 7. During training, the model 710 may ingest historical and in-market datasets from both SUPPLY SIDE PLATFORM and DSP sources, including bid request logs, curated inventory responses, deal identifiers, auction metadata, and campaign performance outcomes. These datasets may be pre-processed to create a unified feature representation that captures the distinct parameter contexts used by SUPPLY SIDE PLATFORMs (e.g., publisher identifiers, site categories, floor prices, contextual tags) and DSPs (e.g., target audience segments, creative formats, pacing rules). The training process may use supervised and reinforcement learning techniques to map combinations of SUPPLY SIDE PLATFORM-side supply parameters and DSP-side demand objectives to observed performance outcomes, enabling the model to identify inventory configurations that yield the highest likelihood of achieving advertiser-defined key performance indicators. As a result, the trained model 710 can, in operation, generate curated inventory selection criteria that are transmitted upstream to SUPPLY SIDE PLATFORMs for inventory shaping and downstream to DSPs for bid price and pacing adjustments, thereby improving both the efficiency of bidstream processing and the relevance of inventory delivered to advertisers. As a significant advantage, this integration of trained predictive models with the real-time, bi-directional SUPPLY SIDE PLATFORM/DSP signaling pathway can improve the performance of programmatic advertising exchanges, enabling more precise, low-latency matching of supply and demand than is achievable using conventional rule-based curation or non-curated auction models.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as described herein.

What is claimed is:

1. A system comprising:
an exchange hosting a bidstream for transacting in online programmatic advertisements;
a supply side platform for programmatic access to the exchange by publishers seeking to sell advertising space in a computer network;
a demand side platform for programmatic access to the exchange by an advertiser seeking to place advertisements on the advertising space in the computer network;
a curation engine configured to:
monitor one or more characteristics for the advertisements placed by the advertiser with the publishers through the exchange,
predict one or more supply side parameters that will improve positive advertisement impressions for the advertiser based on the one or more characteristics, and
request that the supply side platform provide additional advertising space from the publishers to the bidstream meeting the one or more supply side parameters; and
a bidding engine configured to assess inventory in the bidstream and adjust bidding by the advertiser based on whether the inventory meets a performance metric.

2. The system of claim 1, wherein the curation engine includes a machine learning model trained to predict the one or more supply parameters that will improve the positive advertisement impressions for the advertiser based on the one or more characteristics.

3. The system of claim 1, wherein the curation engine includes a rules engine to predict the one or more supply parameters that will improve the positive advertisement impressions for the advertiser based on the one or more characteristics.

4. The system of claim 1, wherein the one or more supply parameters include one or more of geography, audience, publisher, site, domain, advertisement format, device type, media type, floor price, viewability, contextual data, 3^{rd} party data, and publisher category.

5. The system of claim 1, wherein the one or more characteristics for the advertisements include one or more of site, domain, advertisement format, media type, exchange, auction type, DealID, time, viewability, brand safety, fraud, geography, cost, clicks, conversions, and bid price.

6. The system of claim 1, wherein the bidding engine adjusts the bidding based on at least one price parameter.

7. The system of claim 1, wherein the publishers provide web content.

8. The system of claim 7, wherein the advertising space includes advertising space presented to user computers in web browsers while displaying the web content.

9. The system of claim 1, further comprising an advertisement server configured to present an advertisement from the advertiser in web content from one of the publishers in response to completing a sale on the exchange.

10. A computer program product comprising computer executable code embodied in a non-transitory computer readable medium that, when executing one or more computing devices, causes the one or more computing devices to perform the steps of:
receiving, at a curation engine in a programmatic advertising environment, campaign information from an advertiser, the campaign information including at least one performance objective;
receiving, at the curation engine, performance data for advertisements previously placed in advertising inventory offered through a supply side platform;
evaluating the performance data relative to the at least one performance objective to determine performance characteristics of the advertisements;
predicting, based on the performance characteristics, one or more supply side parameters for inventory more likely to achieve the at least one performance objective, the one or more supply side parameters including at least one of geography, audience, publisher, site or domain, advertisement format, device type, media type, floor price, viewability, contextual data, third-party data, or publisher category;
generating inventory selection criteria from the one or more supply side parameters; and
filtering, using the inventory selection criteria, available inventory from the supply side platform to identify curated inventory.

11. The computer program product of claim 10, wherein filtering the available inventory includes transmitting, to the supply side platform, a request to offer the curated inventory into a bidstream.

12. The computer program product of claim 11, wherein transmitting the request to offer the curated inventory comprises generating a curated bid request that includes the inventory selection criteria and sending the curated bid request to the supply side platform via an application programming interface.

13. The computer program product of claim 10, further comprising code that causes the one or more computing devices to perform the step of updating the inventory selection criteria over time based on subsequent performance data for the advertisements placed using the curated inventory.

14. The computer program product of claim 10, wherein predicting the one or more supply side parameters includes executing a machine learning model trained on historical and in-market performance data to identify inventory attributes correlated with achieving the at least one performance objective.

15. The computer program product of claim 10, wherein evaluating the performance data includes correlating advertiser campaign parameters with bid outcomes, impression quality metrics, and conversion rates.

16. The computer program product of claim 10, wherein generating the inventory selection criteria comprises applying a rules engine that incorporates advertiser-defined constraints including budget, brand safety filters, or regulatory compliance flags.

17. The computer program product of claim 10, further comprising code that causes the one or more computing devices to perform the step of transmitting curated inventory parameters from the curation engine to a demand side platform to inform bid pricing or pacing adjustments for an advertising campaign.

18. A method for operating a curation engine in a programmatic advertising environment, the method comprising:
receiving campaign information from an advertiser, the campaign information including at least one performance objective;
receiving performance data for advertisements previously placed in advertising inventory offered through a supply side platform;
evaluating the performance data relative to the at least one performance objective to determine performance characteristics of the advertisements;
predicting, based on the performance characteristics, one or more supply side parameters for inventory more likely to achieve the at least one performance objective;
generating inventory selection criteria from the one or more supply side parameters; and
filtering, using the inventory selection criteria, available inventory from the supply side platform to identify curated inventory.

19. The method of claim 18, wherein filtering the available inventory from the supply side platform includes transmitting, to the supply side platform, a request to offer the curated inventory into a bidstream.

20. The method of claim 18, wherein the one or more supply side parameters including at least one of geography, audience, publisher, site or domain, advertisement format, device type, media type, floor price, viewability, contextual data, third-party data, or publisher category.
